(19) United States
(12) Patent Application Publication
(10) Pub. No.: US 2014/0139955 A1
(43) Pub. Date: May 22, 2014

(54) LEAKAGE PROTECTION PLUG

(71) Applicants: Qihui Ye, Shenzhen (CN); Zhongyu Wang, Shenzhen (CN)

(72) Inventors: Qihui Ye, Shenzhen (CN); Zhongyu Wang, Shenzhen (CN)

(73) Assignee: SHENZHEN LIANGHUI TECHNOLOGY CO., LTD., Shenzhen, Guangdong (CN)

(21) Appl. No.: 14/130,677

(22) PCT Filed: Aug. 9, 2011
(86) PCT No.: PCT/CN2011/078168

§ 371 Date: Jan. 3, 2014

(51) Int. Cl. H02H 3/16

(52) U.S. Cl. CPC H02H 3/162
USPC 361/42

(57) ABSTRACT

The present disclosure provides a leakage protection plug comprising a plug main body having one end connected to a load and the other end connected to an outer power supply through two inserting pieces. A transformer, a trip mechanism, and a PCB control board are arranged inside the plug main body. The transformer detects the leakage current signal between the live wire and the neutral wire and transmits the leakage current signal to the PCB control board. When the PCB control board determines that the current difference between the live wire and the neutral wire is greater than the preset value, the PCB control board outputs the control signal to the trip mechanism. The trip mechanism thus breaks the circuit connection between the power supply and the load. The reset mechanism resets the power supply and the load to connect the power supply with the load again.

### BACKGROUND

1. Technical Field

The present disclosure relates to electrical products, and more particularly, to a leakage protection plug.

2. Description of Related Art

In daily life, short circuits between electrified conductors in an electrical circuit of an electrical product, such as the short circuit between a neutral wire and a live wire, ground, a housing of an electrical equipment, and various kinds of grounded metal tube, etc, or an insulation resistance of the conductor relative to ground being smaller than a preset value, may cause a grounding failure, which may result in an over current and further a fire or an electric shock. In order to avoid the situation, a leakage protection plug is widely applied to avoid the grounding failure.

The leakage protection plug is arranged between a power supply and a load for determining whether there is a leakage in the electrical product by detecting an electrical potential difference between the live wire and the neutral wire. Once the leakage protection plug determines there is a leakage in the circuit, a tripping occurs immediately to break the connection between the power supply and the load to avoid a fire or an electrical shock caused by the leakage.

At present, there are various types of leakage protection plugs for grounding failure. Most of the leakage protection plugs respectively include a first detecting circuit, a main control circuit, an on and off mechanism control circuit, a power supply circuit, and a second detecting circuit. The working principle of the leakage protection plug is as follows: when a reset button of the on and off mechanism is pressed, if the load is normal, the first detecting circuit, the main control circuit, the on and off mechanism control circuit, the power supply circuit, and the second detecting circuit all enter into working states. At this time, the first circuit does not detect any leakage current, the main control circuit does not electrify the on and off mechanism control circuit, an off switch of the on and off mechanism control circuit is closed all the time, and the load work normally. In the working process, once the sensing circuit detects the electrical potential difference between the wire line and the neutral wire, the sensing circuit outputs a grounding failure signal to the main control circuit. The main control circuit amplifies the grounding failure signal and electrifies the on and off mechanism control circuit to open the off switch of the on and off mechanism control circuit. Thus, the current between the power supply and the load is cut off to avoid a fire or an electrical shock caused by the leakage.

When there is a leakage current in the load, although the present leakage protection plug can break the connection between the power supply and the load, an error rate of the leakage protection plug is still relatively high and some undesired breakings may occur. Meanwhile, the performance of the leakage protection circuit is always unstable and thus causes undesired noises and overheat and even a burnt down of the leakage protection plug.

### SUMMARY

The main object of the present disclosure is to provide a leakage protection plug for improving the safety of the leakage protection of an electrical product.

According to the above object, the leakage protection plug provided in the present disclosure includes a plug main body; one end of the plug main body is connected to a load, and a bottom portion of the other end of the plug main body is provided with two inserting pieces connected to an outer power supply; the leakage protection plug further includes:

a transformer configured in the plug main body for determining whether a current flowing through a live wire of the power supply is equal to a current flowing through a neutral wire of the power supply;

a trip mechanism configured in the plug main body and connected to the transformer;

a PCB control board configured in the plug main body for controlling the trip mechanism to break a circuit connection between the power supply and the load when a current difference between the live wire and the neutral wire is greater than a preset value according to a detected signal from the transformer;

a reset mechanism configured in the plug main body for controlling the trip mechanism to reset the connection between the power supply and the load;

the trip mechanism and the reset mechanism being electrically connected to the PCB control board.

Preferably, the live wire and the neutral wire are wrapped around or sleeved on the transformer for determining whether the current flowing through the live wire is equal to the current flowing through the neutral wire.

Preferably, the reset mechanism includes a reset button and a pull rod located under the reset button, a lower end of the pull rod includes a side hook clamped onto the trip mechanism, and a reset spring is sleeved on the pull rod.

Preferably, the trip mechanism includes a circuit breaker, a clamping piece, and an actuator;

the circuit breaker includes a hollow coil former, a coil winding wrapping around the coil former, a pistol rod having a large end and a small end, and a pistol spring sleeved on the small end of the pistol rod; the small end of the pistol spring with the pistol spring sleeved thereon stretches into a cylinder-shaped through hole of the coil former; and one end of the coil former is electrically connected to the PCB control board;

the clamping piece includes a bottom plate and a side plate bent upwards from one side of the bottom plate, an outer surface of the side plate corresponds to an end portion of the small end of the pistol rod, and the bottom plate defines a first hole meshing with the side hook of the lower end of the pull rod;

the actuator includes a rectangular body, an actuator spring, and a pair of movable pieces; a first through hole is defined in a top surface of the rectangular body and extends to a bottom surface of the rectangular body for passing the pull rod therethrough; a second through hole is defined at an upper portion of a left side surface of the rectangular body for accommodating the actuator spring, and a rectangular through hole is defined at a lower portion of the left side surface of the rectangular body for insertively receiving the bottom plate of the clamping piece; an outer end of the actuator spring abuts an upper end of an inner surface of the side plate of the clamping piece; a horizontal arm frame perpendicularly extends from a front side surface and a rear side surface of the rectangular body; one end of the movable piece is secured to the plug main body, the other end of the movable piece is provided with a movable contact engaging with a static contact configured on a rear end of the corresponding inserting piece, and the other end of movable piece is placed on the corresponding horizontal arm frame; when the actuator is clamped onto the pull rod and is moved upwards, the horizontal arm frame drives the movable piece to move upwards until the movable piece engages with the static piece and the power supply is connected with the load; when the actuator is separated from the pull rod, the actuator moves downwards to restore to its original position, the movable contact is separated from the static contact, and the power supply is disconnected from the load.

Preferably, a second hole is defined in an end of the bottom plate which is away from the side plate relative to the first hole, a right side surface of the rectangular body is provided with an exposed protrusion at the rectangular through hole; the second hole in the bottom plate of the clamping piece abuts the exposed protrusion after the bottom plate is inserted into the rectangular hole; a stretching portion extends inwards from an upper end of an inner surface of the side plate for preventing the actuator spring from falling away from the second through hole.

Preferably, the plug main body further includes a plastic cover, and the circuit breaker and the actuator are enclosed in the plastic cover.

Preferably, the plug main body includes an upper cover and a lower cover, and a top surface of the upper cover is an arch surface; the PCB control board, the trip mechanism, and the transformer are arranged inside the lower cover of the plug main body; and the reset button extends out from the plug main body to be above the top surface of the upper cover.

Preferably, the leakage protection plug further includes a detecting mechanism for detecting whether the leakage protection plug works normally; the detecting mechanism includes a test button and a test spring, a contact is configured on a bottom portion of the test button and is connected to the PCB control board, the test spring is configured between the contact configured on the bottom portion of the test button and the PCB control board; and the test button extends out from the plug main body to be above the top surface of the upper cover and is located near one side of the reset button.

Preferably, a top surface of the upper cover of the plug main body is an arch surface, and each of two side surfaces of the lower cover of the plug main body defines a slot.

Preferably, the transformer is an annular plastic housing enclosing a coil winding formed by the live wire and the neutral wire wrapping around the transformer.

As described above, the leakage protection plug of the present disclosure is provided with the transformer, the PCB control board, and the trip mechanism. In general working conditions, the circuit between the power supply and the load is closed by the plug. The transformer detects the leakage current signal between the live wire and the neutral wire and transmits the leakage current signal to the PCB control board. When the PCB control board determines that the current difference between the live wire and the neutral wire is greater than the preset value, the PCB control board outputs the control signal to the trip mechanism. The trip mechanism thus breaks the circuit connection between the power supply and the load to avoid a fire or an electrical shock and to improve the safety of the leakage protection of the product. In addition, the reset mechanism resets the power supply and the load to connect the power supply with the load again, allowing the electrical product to work normally again. In addition, the leakage protection plug is also provided with the detecting mechanism to ensure that the leakage protection plug can work normally and effectively. Moreover, the upper cover of the plug main body includes the arch top surface which satisfies the characteristic of hand grasp and has a rich three-dimensional feeling; the lower cover of the plug main body is provided with two slots easy for the hand grasp at two side surfaces thereof, which allows the leakage protection plug to have a humanization design. The coil winding of the transformer and the coil winding of the circuit breaker are enclosed in the plastic housing to protect nearby components from electromagnetic interferences, to guarantee the stability of the components of the product, and further to guarantee the stability of the whole product.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a perspective schematic view of a leakage protection plug in accordance with an embodiment of the present disclosure;

FIG. 2 is an exploded view of the leakage protection plug of FIG. 1;

FIG. 3 is a schematic view showing a state in which a pull rod moves downwards after a reset button is pressed;

FIG. 4 is a schematic view showing a state in which the pull rod meshes with a clamping piece;

FIG. 5 is a schematic view showing a state in which a pistol moves towards the clamping piece in a grounding failure state; and

FIG. 6 is a schematic view showing a state in which the pistol rod is separated from the clamping piece.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Solution provided in the present disclosure is: a transformer detects a leakage current signal between a live wire and a neutral wire of a power supply and transmits the leakage current signal to a PCB control board; the PCB control board outputs a control signal to a trip mechanism when determining that an electrical potential difference between the live wire and the neutral wire is greater than a preset value; the trip mechanism breaks a circuit connection between the power supply and a load to avoid a fire or an electrical shock, and thus improves the safety of the leakage protection of the electrical product.

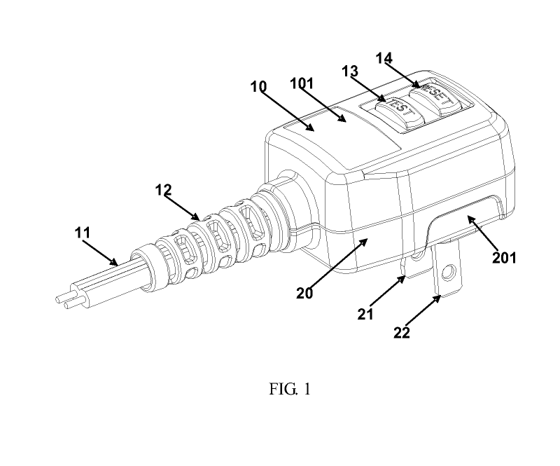

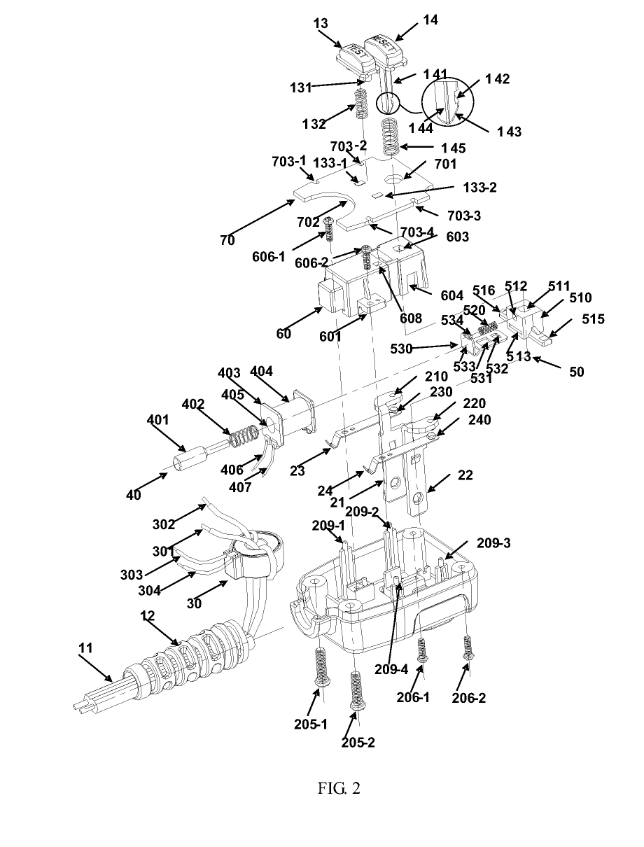

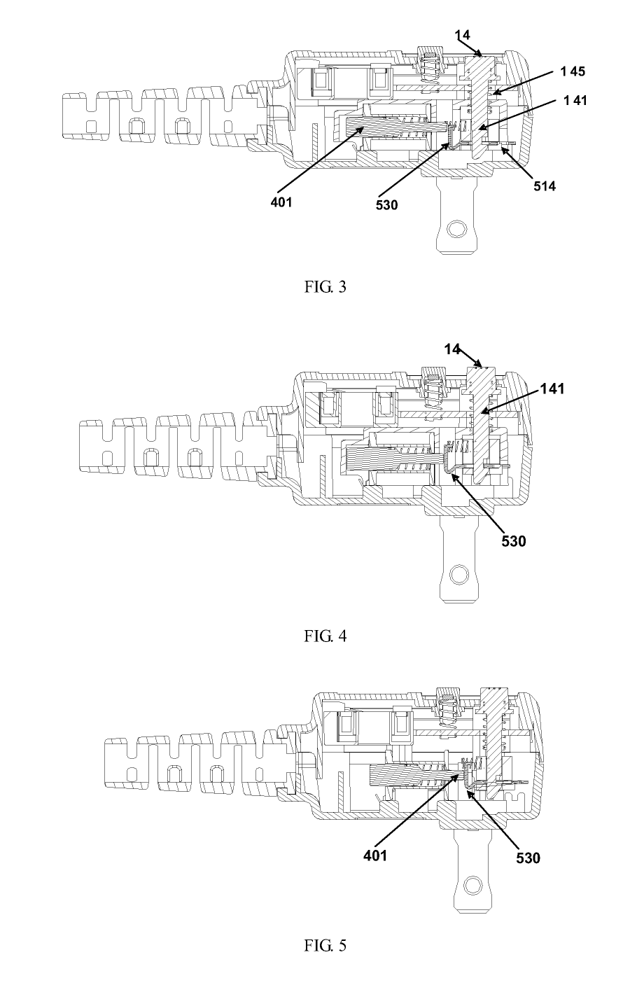

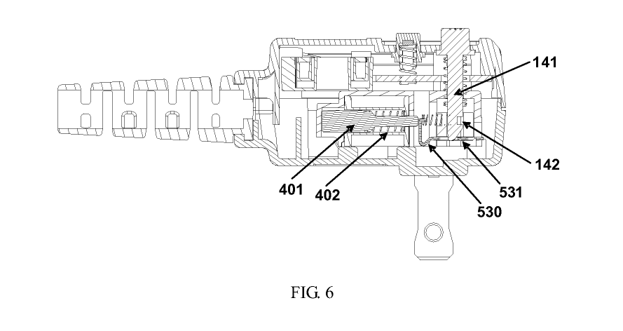

FIG. 1 is a perspective schematic view of a leakage protection plug in accordance with an embodiment of the present disclosure; FIG. 2 is an exploded view of the leakage protection plug of FIG. 1; FIG. 3 is a schematic view showing a state in which a pull rod moves downwards after a reset button is pressed; FIG. 4 is a schematic view showing a state in which the pull rod meshes with a clamping piece; FIG. 5 is a schematic view showing a state in which a pistol rod moves towards the clamping piece in a grounding failure state; and FIG. 6 is a schematic view showing a state in which the pistol rod is separated from the clamping piece.

The leakage protection plug provided in an embodiment of the present disclosure includes a plug main body. The plug main body includes a top surface 10, a bottom surface, a side surface, a left end, a right end, and a reset button 14 and a test button 13 located on the top surface 10. A power wire 11 including a live wire 301 and a neutral wire 302 extends from the left end of the plug main body 10 and is connected to the load. Two inserting pieces 21, 22 extend from the bottom surface of the plug main body and are connected to an outer power supply socket to realize the connection between the power supply and the load.

The plug main body in the embodiment includes an upper cover 10 and a lower cover 20. A top surface of the upper cover 10 is an arch surface. Front and rear sides of the lower cover 20 respectively define a slot 201 easy for hand grasp. The two slots 201 allow the leakage protection plug to be held stably and uneasy to fall down during the insertion and extraction of the leakage protection plug.

The upper cover 10 and the lower cover 20 are assembled together via screws 205-1, 205-2, 206-1, and 206-2. The two inserting pieces 21, 22 are secured to a bottom portion of the lower cover 20. Rear ends of the inserting piece 21 and 22, that is, ends of the inserting piece 21 and 22 located in the plug main body are provided with static contacts 210 and 220.

The transformer 30, the PCB control board 70, and the trip mechanism are configured inside the lower cover 20. The transformer 30 and the trip mechanism are electrically connected to the PCB control board 70. The transformer 30 is arranged in parallel with the trip mechanism. The PCB control board 70 is located above the transformer 30 and the trip mechanism and is under the reset button 14 and the test button 13. The upper cover 10 is provided with a reset mechanism of the reset button 14 and a test mechanism of the test button 13.

The transformer 30 is an annular plastic housing. The live wire 301 and the neutral wire 302 extend into the leakage protection plug from the left end of the leakage protection plug through a protection pipe 12. A coil winding formed by the live wire 301 and the neutral wire 302 is welded on two movable pieces 23 and 24 (detail will be given in the following) of the trip mechanism inside the leakage protection plug after passing through or wrapping around the transformer 30. The transformer 30 is configured for judging whether a current flowing through the live wire 301 is equal to a current flowing through the neutral wire 302. In normal conditions, the current flowing through the live wire 301 is equal to the current flowing through the neutral wire 302. When a leakage current occurs, there is a current difference between the live wire 301 and the neutral wire 302, the transformer 30 outputs the detected leakage current signal between the live wire 301 and the neutral wire 302 to the PCB control board 70.

The PCB control board 70 is provided with a control chip to continuously detect the leakage current signal outputted from the transformer 30. When the PCB control board 70 determines that the signal difference between the live wire 301 and the neutral wire 302 is greater than the preset value, the PCB control board 70 controls the trip mechanism to break the circuit connection between the power supply and the load.

After the circuit connection between the power supply and the load are broken, the reset mechanism reset the trip mechanism to connect the power supply with the load again.

Specifically, the reset mechanism includes the reset button 14 and a pull rod 141 located under the reset button 14. A lower end 144 of the pull rod 141 includes a side hook 143 clamped onto the trip mechanism. The side hook 143 has an opening 142. A reset spring is sleeved on the pull rod 141.

The trip mechanism 40 includes a circuit breaker 40, a clamping piece 530, and an actuator 50.

The circuit breaker 40 includes a hollow coil former 403, a coil winding 404 wrapping around the coil former 403, a pistol rod 401 having a relatively large end and a relatively small end, and a pistol spring 402 sleeved on the small end of the pistol rod 401. The small end of the pistol rod 401 with the pistol spring 402 sleeved thereon stretches into a cylinder-shaped through hole 405 of the coil former 403. One end of the coil former 403 is electrically connected to the PCB control board 70 through leads 406 and 407.

The clamping piece 530 includes a bottom plate and a side plate 533 bent upwards from a side of the bottom plate. An outer surface of the side plate 533 corresponds to an end portion of the small end of the pistol rod 401. The bottom plate defines a first hole 531 capable of meshing with the side hook 143 of the lower end of the pull rod 141.

In normal working conditions, the side hook 143 of the lower end 144 of the pull rod 141 meshes with the first hole 531 of the clamping piece 530. When the leakage current is greater than the preset value, the coil winding 404 of the circuit breaker 40 generates a magnetic force large enough to push the pistol rod 401 to compress the pistol spring 402 and also push the pistol rod 141 to move towards the clamping piece 530 (as shown in FIG. 5), which separates the clamping piece 530 from the pull rod 141 and thus breaks the circuit connection between the power supply and the load.

The actuator 50 includes a rectangular body 510, an actuator spring 520, and a pair of movable pieces 23 and 24. A first through hole 511 is defined in a top surface of the rectangular body 510, extending from the top surface of the rectangular body 510 to a bottom surface of the rectangular body 510. The first through hole 511 is aligned with the first hole 531 in the bottom plate of the clamping piece 530, thus, the pull rod 141 can pass through the first through hole 511 to mesh with the first hole 531. A second through hole 512 is defined at an upper portion of a left side surface of the rectangular body 510 for placing the actuator spring 520. A rectangular hole 513 running through the rectangular body 510 is defined at a lower portion of the left side surface of the rectangular body 510, for allowing the bottom plate of the clamping piece 530 to be inserted therein. An outer end of the actuator spring 520 abuts an upper end of an inner surface of the side plate 533. An stretching portion 534 extends inwards from the upper end of the inner surface of the side plate 533 for preventing the actuator spring 520 from falling away from the second through hole 512 in the upper portion of the left side surface of the rectangular body 510.

Two horizontal arm frames 515 and 516 respectively extend from front and rear side surfaces of the rectangular body 510. One ends of the movable pieces 23 and 24 are secured to the plug main body, and the other ends of the movable pieces 23 and 24 are respectively provided with movable contacts 230 and 240 which engage with the static contacts 210 and 220 on the rear end of the inserting pieces 21 and 22. The movable contacts 230 and 240 are silver snails. The other ends of the movable pieces 23 and 24 are respectively placed on the horizontal arm frames 516 and 515. When the movable pieces 23 and 24 are pulled upwards, the static contacts 210 and 220 engage with the movable contacts 230 and 240 to connect the power supply, thereby connecting the load with the power supply.

Specifically, when the actuator 50 is clamped onto the pull rod 141 and is moved upwards, the horizontal arm frames 515 and 516 drive the movable pieces 23 and 24 to move upwards until the movable contacts 230 and 240 engage with the static contacts 210 and 220, the load thus is connected to the power supply. When the actuator 50 is separated from the pull rod 141, the actuator 50 moves downwards to restore to its original position, the movable contacts 230 and 240 are separated from the static contacts 210 and 220, and the load is disconnected from the power supply.

Moreover, a second hole 532 is defined at another end of the bottom plate which is away from the side plate 533 relative to the first hole 531. A right side surface of the rectangular body 510 is provided with an exposed protrusion 514 at the rectangular hole. After the bottom plate of the clamping piece is inserted into the rectangular hole 513, the exposed protrusion 514 abuts the second hole 532 in the bottom plate, as shown in FIG. 3, which limits the moving range of the clamping piece 530 and avoids the shaking and unstability of the clamping piece 530.

In practical applications, when the reset button 14 is pressed, the pull rod 141 moves downwards to mesh with the first hole 531 of the clamping piece 530 by passing through the first through hole 511 in the top surface of the rectangular body 510, thus the pull rod 141 is clamped onto the clamping piece 530 (as shown in FIG. 3). The second hole 532 engages with the exposed protrusion 514 located on the right side surface of the rectangular body 510 of the actuator 50 to limit the moving range of the clamping piece 530 and avoid the shaking of the clamping piece.

In addition, the actuator spring 520 is mounted into the second through hole 512 at the upper portion of the left side surface of the rectangular body 510, and the clamping piece 530 and the rectangular body 510 are assembled together through the rectangular hole 513 of the rectangular body 510. In assembly, the stretching portion 534 is inserted into the actuator spring 520 to prevent the actuator spring 520 from falling away from the second through hole 512. On the other hand, when the pistol rod 401 moves towards under the magnetic force from the circuit breaker 40, the pistol rod 401 pushes the clamping piece 530 to move forwards (as shown in FIG. 5) through the rectangular hole 513 of the actuator 50, which not only separates the pull rod 141 from the clamping piece 530, but also compresses the actuator spring 520. Once the pull rod 141 is separated from the clamping piece 530, the actuator spring 520 rebounds and drives the clamping piece 530 to move back to its original position.

A plastic cover 60 is mainly used for covering the circuit breaker 40 and the actuator 50. The plastic cover 60 includes a pair of side arms 601 and 602 (not shown in the drawings) which have identical structures and are opposite to each other. The side arms 601 and 602 respectively define a screw hole. An opening 603 is defined in a top surface of the plastic cover 60 and the opening 603 has a size being the same as that of the first through hole 511 defined in the top surface of the actuator 50. Two square holes 608 and 609 (not shown in the drawings) allowing the leads of the circuit breaker 40 to pass therethrough are also defined in the top surface of the plastic cover 60. Two openings 604 and 605 (not shown) of the same shapes are defined in side surfaces of the plastic cover 60.

In practical applications, screws 606-1 and 606-2 are screwed into the screw holes to secure the plastic cover 60 to the lower cover 20. The opening 603 is configured for allowing the pull rod 141 to pass therethrough, and the openings 604 and 605 are configured for facilitating the horizontal arm frames 515 and 516 to move upwards. Furthermore, since the plastic cover 60 can cover the circuit breaker 40 completely, the plastic cover 60 can avoid the leakage of electromagnetism of the circuit breaker 4 to protect nearby components from electromagnetic interferences, thereby playing a part in electromagnetic interference protection.

It is noted that a plastic housing can be used for enclosing the coil winding of the transformer 30, which also can avoid the leakage of electromagnetism of the coil winding and play a part in electromagnetic interference protection and ensures the stability of the performance of each component.

Each electrical product is a source of electromagnetic irradiation. Sometimes the amount of electromagnetic irradiation is too small to interfere with nearby components, thus, the electromagnetic irradiation can be ignored. However, sometimes the electromagnetic irradiation is so strong that usages of nearby components are affected. In serious cases, the electromagnetic irradiation may cause failures of nearby components, which may severely affect the performance and safety of the product. In general conditions, the magnetic coil winding causes electromagnetic interferences with nearby components, which may affect performances of nearby components a lot if no protection is applied. In order to eliminate the undesirable influence from the electromagnetic irradiation, isolation designs are applied to magnetic components of the embodiment, that is, the coil winding of the circuit breaker 40 and the coil winding of the transformer 30 are enclosed in the plastic housing, thus, the coil windings are isolated from nearby components by the plastic housing to protect nearby components from the electromagnetic interferences, and to guarantee the stabilities of the components of the product and the stability of the whole product.

All the components of the embodiment are arranged on the PCB control board 70. The PCB control board 70 includes a through hole 701, two contacts 133-1 and 133-2, a semicircle-shaped opening 702, and n-shaped openings 703-1, 703-2, 703-2, and 703-4 arranged around the semicircle-shaped opening 702. Similar to the opening 603 in the plastic cover 60, the through hole 701 is also provided to allow the pull rod 141 to pass therethrough. The semicircle-shaped opening 702 is defined to cooperatively position the transformer 30. The n-shaped openings 703-1, 703-2, 703-3, and 703-4 are defined to cooperatively engage with positioning pins 209-1, 209-2, 209-3, and 209-4 on the lower cover to secure the PCB control board 70.

In practical applications, the pull rod 141 of the reset mechanism passes through the PCB control board 70 and the opening 603 in the plastic cover 60 to extend towards the rectangular hole 513 of the actuator 50. When the reset button 14 is pressed, on one hand, the reset spring 145 is compressed; on the other hand, the pull rod 141 moves downwards and passes through the first hole 531 in the clamping piece 530 to mesh with the clamping piece 530 via the opening 142 in the side hook 143 of the pull rod 141 (as shown in FIG. 3). When the reset button is released, the reset spring 145 rebounds to drive the pull rod 141 to move upwards and further drive the actuator 50 to move upwards together (as shown in FIG. 4). As the actuator 50 moves upwards, the movable contacts 230 and 240 are driven to engage with the static contacts 210 and 220, thereby connecting the load with the power supply. At this time, the pistol rod 401 does not contact the clamping piece 530, and a distance is defined between the pistol rod 401 and the clamping piece 530 (as shown in FIG. 4).

The detecting mechanism of the embodiment detects whether the leakage protection plug work normally by simulating the grounding failure. The detecting mechanism includes the test button 13 and the test spring 132. A contact 131 connected to the PCB control board 70 is configured on a bottom portion of the test button 13. The test spring 132 is configured between the contact 131 and the PCB control board 70.

In general conditions, the test spring 132 and the test button 13 are assembled together, and the test spring 132 and the test button 13 as a whole is spaced from the contacts 133-1 and 133-2 of the PCB control board 70. When the test button 13 is pressed, the test spring 132 is compressed to touch the contacts 133-1 and 133-2 of the PCB control board. Once the contacts 133-1 and 133-2 of the PCB control board are touched, the grounding failure condition is generated. At this time, the circuit breaker 40 may generate a magnetic force large enough to push the pistol rod 401 to move towards the clamping piece 530 (as shown in FIG. 5) and to push the clamping piece 530 to move as well. At the same time, the pistol rod 401 compresses the pistol spring 402. In addition, as the clamping piece 530 moves forwards, the actuator spring 520 is also compressed, and the pull rod 141 which originally meshes with the first hole 531 in the clamping piece 530 via the opening 142 of the pull rod 141 does not mesh with the clamping piece 530. The reset spring 145 rebounds to pull the pull rod 141 upwards, thereby separating the pull rod 141 from the clamping piece 530 (as shown in FIG. 6). Once the pull rod 141 is separated from the clamping piece 530, the pistol spring 402 rebounds to restore the pistol rod 401 to its original position, and the actuator spring 520 also rebounds to restore the clamping piece 530 to its original position.

As described above, the leakage protection plug of the present disclosure is provided with the transformer 30, the PCB control board 70, and the trip mechanism. In general working conditions, the circuit between the power supply and the load is closed by the plug. The transformer 30 detects the leakage current signal between the live wire 301 and the neutral wire 302 and transmits the leakage current signal to the PCB control board 70. When the PCB control board 70 determines that the current difference between the live wire 301 and the neutral wire 302 is greater than the preset value, the PCB control board 70 outputs the control signal to the trip mechanism. The trip mechanism thus breaks the circuit connection between the power supply and the load to avoid a fire or an electrical shock and to improve the safety of the leakage protection of the product. In addition, the reset mechanism resets the power supply and the load to connect the power supply with the load again, allowing the electrical product to work normally again. In addition, the leakage protection plug is also provided with the detecting mechanism to ensure that the leakage protection plug can work normally and effectively. Moreover, the upper cover of the plug main body includes the arch top surface which satisfies the characteristic of hand grasp and has a rich three-dimensional feeling; the lower cover of the plug main body is provided with two slots easy for the hand grasp at two side surfaces thereof, which allows the leakage protection plug to have a humanization design. The coil winding of the transformer and the coil winding of the circuit breaker are enclosed in the plastic housing to protect nearby components from electromagnetic interferences, to guarantee the stability of the components of the product, and further to guarantee the stability of the whole product.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

1. A leakage protection plug comprising a plug main body, one end of the plug main body being connected to a load, and a bottom portion of the other end of the plug main body being provided with two inserting pieces connected to an outer power supply; the leakage protection plug further comprising:
a transformer configured in the plug main body for determining whether a current flowing through a live wire of the power supply is equal to a current flowing through a neutral wire of the power supply;
a trip mechanism configured in the plug main body and connected to the transformer;
a PCB control board configured in the plug main body for controlling the trip mechanism to break a circuit connection between the power supply and the load when a current difference between the live wire and the neutral wire is greater than a preset value according to a detected signal from the transformer;
a reset mechanism configured in the plug main body for controlling the trip mechanism to reset the connection between the power supply and the load;
the trip mechanism and the reset mechanism being electrically connected to the PCB control board.

2. The leakage protection plug of claim 1, wherein the live wire and the neutral wire are wrapped around or sleeved on the transformer for determining whether the current flowing through the live wire is equal to the current flowing through the neutral wire.

3. The leakage protection plug of claim 2, wherein the reset mechanism comprises a reset button and a pull rod located under the reset button, a lower end of the pull rod comprises a side hook clamped onto the trip mechanism, and a reset spring is sleeved on the pull rod.

4. The leakage protection plug of claim 3, wherein the trip mechanism comprises a circuit breaker, a clamping piece, and an actuator;
the circuit breaker comprises a hollow coil former, a coil winding wrapping around the coil former, a pistol rod having a large end and a small end, and a pistol spring sleeved on the small end of the pistol rod; the small end of the pistol spring with the pistol spring sleeved thereon stretches into a cylinder-shaped through hole of the coil former; and one end of the coil former is electrically connected to the PCB control board;
the clamping piece comprises a bottom plate and a side plate bent upwards from one side of the bottom plate, an outer surface of the side plate corresponds to an end portion of the small end of the pistol rod, and the bottom plate defines a first hole meshing with the side hook of the lower end of the pull rod;
the actuator comprises a rectangular body, an actuator spring, and a pair of movable pieces; a first through hole is defined in a top surface of the rectangular body and extends to a bottom surface of the rectangular body for passing the pull rod therethrough; a second through hole is defined at an upper portion of a left side surface of the rectangular body for accommodating the actuator spring, and a rectangular through hole is defined at a lower portion of the left side surface of the rectangular body for insertively receiving the bottom plate of the clamping piece; an outer end of the actuator spring abuts an upper end of an inner surface of the side plate of the clamping piece; a horizontal arm frame perpendicularly extends from a front side surface and a rear side surface of the rectangular body; one end of the movable piece is secured to the plug main body, the other end of the movable piece is provided with a movable contact engaging with a static contact configured on a rear end of the corresponding inserting piece, and the other end of movable piece is placed on the corresponding horizontal arm frame; when the actuator is clamped onto the pull rod and is moved upwards, the horizontal arm frame drives the movable piece to move upwards until the movable piece engages with the static piece and the power supply is connected with the load; when the actuator is separated from the pull rod, the actuator moves downwards to restore to its original position, the movable contact is separated from the static contact, and the power supply is disconnected from the load.

5. The leakage protection plug of claim 4, wherein a second hole is defined in an end of the bottom plate which is away from the side plate relative to the first hole, a right side surface of the rectangular body is provided with an exposed protrusion at the rectangular through hole; the second hole in the bottom plate of the clamping piece abuts the exposed protrusion after the bottom plate is inserted into the rectangular hole; a stretching portion extends inwards from an upper end of an inner surface of the side plate for preventing the actuator spring from falling away from the second through hole.

6. The leakage protection plug of claim 4, wherein the plug main body further comprises a plastic cover, and the circuit breaker and the actuator are enclosed in the plastic cover.

7. The leakage protection plug of claim 6, wherein the plug main body comprises an upper cover and a lower cover, and a top surface of the upper cover is an arch surface; the PCB control board, the trip mechanism, and the transformer are arranged inside the lower cover of the plug main body; and the reset button extends out from the plug main body to be above the top surface of the upper cover.

8. The leakage protection plug of claim 7 further comprising a detecting mechanism for detecting whether the leakage protection plug works normally; the detecting mechanism comprises a test button and a test spring, a contact is configured on a bottom portion of the test button and is connected to the PCB control board, the test spring is configured between the contact configured on the bottom portion of the test button and the PCB control board; and the test button extends out from the plug main body to be above the top surface of the upper cover and is located near one side of the reset button.

9. The leakage protection plug of claim 8, wherein a top surface of the upper cover of the plug main body is an arch surface, and each of two side surfaces of the lower cover of the plug main body defines a slot.

10. The leakage protection plug of claim 9, wherein the transformer is an annular plastic housing enclosing a coil winding formed by the live wire and the neutral wire wrapping around the transformer.

11. The leakage protection plug of claim 5, wherein the plug main body further comprises a plastic cover, and the circuit breaker and the actuator are enclosed in the plastic cover.
